(19) United States
(12) Patent Application Publication
(10) Pub. No.: US 2014/0288195 A1
(43) Pub. Date: Sep. 25, 2014

(54) PROCESS FOR THE THERMOCHEMICAL CONVERSION OF A CARBON-BASED FEEDSTOCK TO SYNTHESIS GAS CONTAINING PREDOMINANTLY H2 AND CO

(71) Applicant: COMMISSARIAT A L'ENERGIE ATOMIQUE ET AUX ENERGIES ALTERNATIVES, Paris (FR)

(72) Inventors: Pierre Castelli, Saint Nazaire Les Eymes (FR); Guillaume Boissonnet, Grenoble (FR)

(73) Assignee: COMMISSARIAT A L'ENERGIE ATOMIQUE ET AUX ENERGIES ALTERNATIVES, Paris (FR)

(21) Appl. No.: 14/354,609

(22) PCT Filed: Oct. 31, 2012
(86) PCT No.: PCT/EP12/71594

§ 371 Date: Apr. 28, 2014

(30) Foreign Application Priority Data
Nov. 4, 2011 (FR) 1159985

(51) Int. Cl. C07B 41/02; C01B 3/02

(52) U.S. Cl. CPC C07B 41/02; C01B 3/02
USPC 518/700; 252/373

(57) ABSTRACT

The invention relates to a novel process for the thermochemical conversion of a carbon-based feedstock to synthesis gas containing predominantly hydrogen (H₂) and carbon monoxide (CO). The process comprises (a) oxycombustion of the carbon-based feedstock to create a cogeneration of electricity and of heat; (b) high-temperature electrolysis (HTE) of water using at least the heat produced according to step (a); and (c) reverse water gas shift (RWGS) reaction starting from the carbon dioxide (CO₂) produced according to step (a) and the hydrogen (H₂) produced according to step (b).

### TECHNICAL FIELD

The invention relates to a novel process for the thermochemical conversion of a carbon-based (carbonaceous) feedstock to synthesis gas containing predominantly hydrogen (H₂) and carbon monoxide (CO), with a view to producing liquid (Fischer-Tropsch “FT” diesel, dimethyl ether “DME”, methanol) or gaseous (synthetic natural gas (SNG) fuels, or other synthetic chemicals, such as methanol for example.

The main intended application of the invention is that for which the carbon-based feedstock is biomass.

### PRIOR ART

The term “carbon-based feedstock” designates any combustible material constituted of carbon-containing compounds.

It may thus be biomass, in other words any inhomogeneous material of plant origin containing carbon, such as lignocellulosic biomass, forest or farming (straw) waste, which may be quasi-dry or soaked with water, such as household wastes.

It may also be a fossil fuel, such as coal.

It may also be combustible wastes of industrial origin containing carbon, such as plastic materials or tyres.

It may also be a combination of biomass and of fossil fuels.

Current processes being studied or at the industrial pilot scale, making it possible to convert by a thermochemical route biomass into liquid fuel by a chemical synthesis according to the process widely known by the name “Fischer Tropsch process”, necessarily comprise a step of gasification of the biomass with steam to obtain a synthetic gas containing predominantly carbon monoxide (CO) and hydrogen (H₂). The Fischer Tropsch process then makes it possible, starting from CO and H₂, to obtain —CH₂— chains similar to that of diesel according to the following equation:

(2n+1)H₂+nCO→CₙH₂ₙ₊₂₊nH₂O.

The actual step of gasification is carried out continuously starting from biomass of different nature and particle sizes stored normally at atmospheric pressure, in a chemical reactor (gasification reactor), either of the fluidised bed type or of the entrained flow type operating under pressure.

Fluidised bed type reactors are less efficient on account of the reaction temperature comprised generally between 800° C. and 1000° C., which leads to a lower conversion of the biomass into CO and H₂ synthesis gas with the generation among others of methane (CH₄). They have the advantage on the other hand of only requiring a drying and a moderate particle size grinding of the biomass without other specific preparation. The drying and grinding only lead to a slight loss of efficiency of the overall process. Fluidised bed reactors can be adapted to produce synthetic natural gases (SNG).

Entrained flow reactors have for their part excellent conversion efficiency of the biomass into CO and H₂ synthesis gas, and are thus entirely suitable for the production of fuels or synthetic chemicals from biomass. They thus serve at the moment as reference in the field of fuels designated by the term BtL (Biomass to Liquid). However, they require a thermal pre-treatment of the biomass so that it can be ground with a fine particle size and injected easily, which introduces a loss of mass or energy and thus a reduction in the efficiency for the process.

The input of heat of currently known processes is achieved in general by the combustion of part of the biomass itself (raw biomass, gas, solid residues, tars, etc.). These processes are known as “autothermic”. In autothermic processes, part of the carbon stemming from the biomass is thus not converted into liquid fuel.

The input of heat of the process may be achieved by an external heat source, preferably of nuclear electrical origin without emission of CO₂.

These processes are known as “allothermic”, with as advantage a mass efficiency greater than that of autothermic processes.

Whatever the technology of the reactors retained, and as mentioned above, gasification has the major drawback of requiring specific preparation of the biomass, such as torrefaction, which is energy consuming and makes the material yield drop.

The patent application US 2009/0235587 discloses a process for producing a synthesis gas from the heat produced during the oxidation of a carbon-based feedstock.

Furthermore, it is widely known to incinerate household wastes to produce cogeneration of electricity and of heat. Moreover, it has already been envisaged to carry out an oxycombustion of household wastes: see [1].

Finally, a technical-economic evaluation of different processes for transforming biomass into liquid fuel (biofuel) with different variants has already been done: a presentation thereof is given in [2].

The goal of the invention is to provide a novel process for the thermochemical conversion of a carbon-based feedstock to synthesis gas containing predominantly hydrogen (H₂) and carbon monoxide (CO), with a view to producing liquid fuels or other synthetic chemicals, which has better energy and/or mass efficiency than that of currently known processes.

A particular goal is to provide a novel process for the thermochemical conversion of a carbon-based feedstock to synthesis gas which makes it possible to attain better energy and/or mass efficiency than those of processes evaluated economically in the publication [2].

### DESCRIPTION OF THE INVENTION

To do so, the subject matter of the invention is a process for the conversion of a carbon-based (carbonaceous) feedstock to synthesis gas containing predominantly (a majority of) hydrogen (H₂) and carbon monoxide (CO), comprising the following steps:

a/ oxycombustion of the carbon-based feedstock to create a cogeneration of electricity and of heat;

b/ high-temperature electrolysis (HTE) of water using at least the heat produced according to step a/;

c/ reverse water gas shift (RWGS) reaction starting from the carbon dioxide (CO₂) produced according to step a/ and the hydrogen (H₂) produced according to step b/.

Oxycombustion is taken to mean the currently widespread definition, as detailed at the following internet address:

http://en.wikipedia.org/wiki/Oxyfuel combustion process,

in other words a combustion based on air enriched with oxygen—namely with an oxygen O₂ level generally above the oxygen level of air, which is generally 21% by volume (O₂>21%)-, or on pure 0₂, as an oxidising agent.

Generally, oxycombustion produces essentially, or even uniquely, CO₂ as gas, without CO. Generally, all the carbon of the carbon-based feedstock is transformed into CO₂.

According to an advantageous embodiment, the high temperature electrolysis (HTE) of water of step b/ is also carried out using the electricity produced according to step a/. The efficiency of the process is further increased because less external energy needs to be input into the process.

The invention is a combination of elementary processes known individually and already proven but which had never been all three coupled together with a view to producing synthesis gas containing predominantly hydrogen and carbon monoxide.

Thus, firstly, not implementing gasification of the carbon-based feedstock enables considerably reduced energy consumption at input of the conversion process because:
there is no need for any specific preparation of the carbon-based feedstock, and particularly of the biomass (grinding, torrefaction, etc.);
a decrease of nitrogen oxides is obtained due to the combustion using enriched or pure oxygen instead of air;
high combustion temperatures can be obtained enabling better efficiency of electricity production by the cogeneration step, and thereby enabling a reduced electricity consumption for the process;
there is no loss of heat through the sensible heat of nitrogen N₂ compared to conventional combustion using air, and thus better energy efficiency.

The use of heat and preferably concomitantly of the electricity produced by the oxycombustion in high temperature electrolysis also makes it possible to have reduced energy consumption (exterior input).

As detailed hereafter, the inventors have conducted initial assessments of the energy and mass efficiencies of the process according to the invention and they have highlighted that the performances attained are much better than those currently of known Btl reference processes.

Until now, it had not been envisaged to implement the reaction known as RWGS (reverse water gas shift), simultaneously from on the one hand the CO₂ produced by the oxycombustion of biomass and on the other hand from the hydrogen produced by the high-temperature electrolysis (HTE) of water.

As regards the envisaged implementations of step b/ of high temperature electrolysis, for optimal efficiency, in particular optimal temperatures and reactors, reference may advantageously be made to the different publications and patent applications in the name of the applicant.

As regards step c/ of reverse water gas shift (RWGS) reaction, it may be carried out at around 800° C. with catalysts. It may also be advantageously implemented in homogeneous medium, in other words without catalyst, at high temperatures with a conversion efficiency as high as possible at the lowest energy cost, and without producing undesirable gases such as methane, as proposed by the applicant in the patent application FR 10 61178 filed on the 23 Dec. 2010, published on the 24 Feb. 2012 as FR-A1-2 963 932 and entitled “Procédé de recyclage amélioré du CO₂ par réaction inverse du gaz à I'eau (RWGS)” (Improved process for recycling CO₂ by reverse water gas shift (RWGS) reaction).

According to a variant, all the oxygen produced by the electrolysis (HTE) according to step b/ is used as oxidising agent of step a/ of oxycombustion.

Alternatively, only part of the oxygen produced by the electrolysis (HTE) according to step b/ is used as oxidising agent of step a/ of oxycombustion, the other part being recovered.

Preferably, the water (H₂O) produced by the RWGS reaction according to step c/ is recycled and injected as input product of the HTE electrolysis according to step b/.

Even more preferably, the process further comprises a step d/ of cleaning (scrubbing) the gas obtained according to step c/ so as to extract hydrogen (H₂) and carbon monoxide (CO). The carbon dioxide (CO₂) cleaned (scrubbed) according to step d/ is preferably injected as input product of the RGWS reaction according to step c/.

The water (H₂O) derived from the cleaning (scrubbing) of the gas according to step d/is also preferably recycled and injected as input product of the HTE electrolysis according to step b/.

Preferably, the carbon monoxide (CO) and hydrogen (H₂) derived from the cleaning according to step d/ are injected as input products of a step e/ according to which a Fischer Tropsch (FT) synthesis is carried out to obtain a liquid fuel.

Advantageously, the water (H₂O) derived from the Fischer Tropsch FT synthesis according to step e/ is recycled and injected as input product of the HTE electrolysis according to step b/.

Even more advantageously, the overhead gas of the FT synthesis according to step e/is injected as input product of the oxycombustion according to step a/.

The heat generated by the FT synthesis according to step e/ may serve preferably in the production of steam at input of the HTE electrolysis according to step b/.

The process applies advantageously to a carbon-based feedstock which is biomass, with preferably a biomass moisture level of less than 50%. The oxycombustion of the biomass produces water and CO₂, this water may be recycled in the process according to the invention and it is sufficient in quantity for this. The biomass must thus be sufficiently dry, because the water contained in the biomass is going to be heated pointlessly and thus reduce the efficiency of the process. Also, a moisture level of less than 50% is advantageous.

### BRIEF DESCRIPTION OF THE DRAWINGS

Other advantages and characteristics of the process according to the invention will become clearer on reading the detailed description of the invention made with reference to the following figures, among which:

FIG. 1 is a schematic layout of an embodiment of the process according to the invention;

FIG. 2 reproduces the layout of FIG. 1 while including therein the material balances (species consumed or produced at each step of the process).

### DETAILED DESCRIPTION OF PARTICULAR EMBODIMENTS

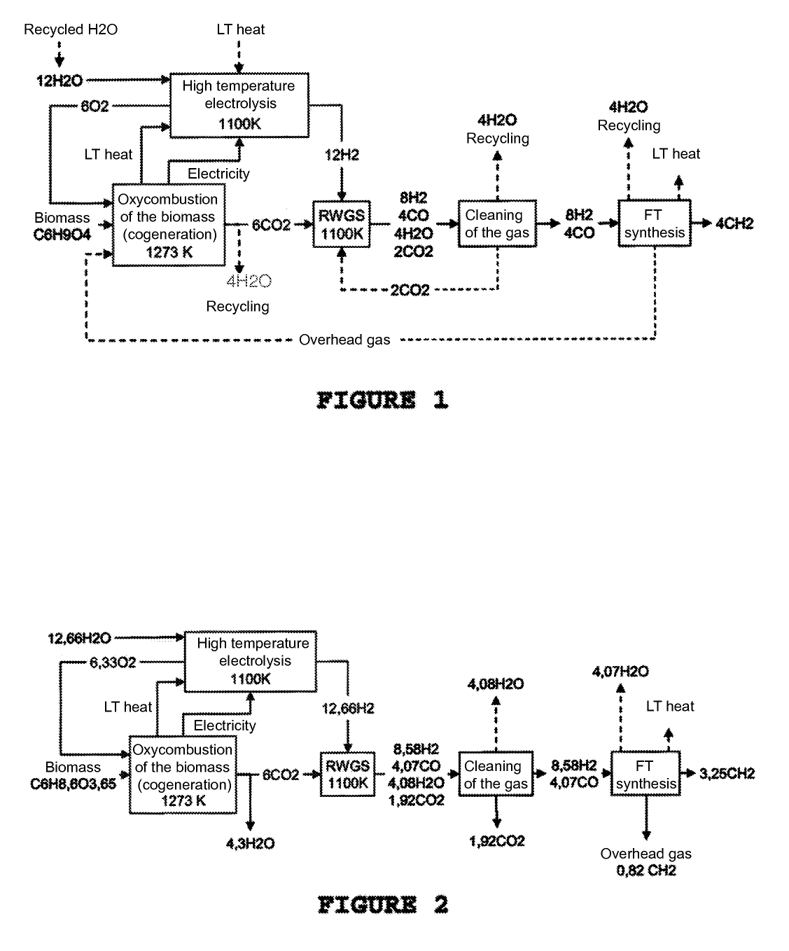

As may be seen in FIG. 1, the process for the thermochemical conversion of the biomass C₆H₉O₄ at input according to the invention consists in carrying out the following steps in combination:

a/ an oxycombustion of the biomass, preferably at temperatures of the order of 1273 K to create a cogeneration of heat at high temperatures of the order of 1100 K and of electricity. Preferably, this step a/ of oxycombustion is carried out in a cogeneration reactor of fluidised bed type.

b/ a high temperature electrolysis (HTE) of the water, preferably at temperatures close to 1100 K, the HTE electrolysis being carried out by input of all the heat and all the electricity produced by the cogeneration according to step a/. As indicated in dotted lines in FIGS. 1 and 2, the water produced according to the oxycombustion may be recycled and injected as input product of the electrolysis according to step b/.

c/ a reverse water gas shift (RWGS) reaction starting from the carbon dioxide (CO₂) produced according to step a/ and the hydrogen (H₂) produced according to step b/. Preferably, this RWGS step c/ is carried out in a catalytic type reactor or a high temperature reactor.

According to step c/, a synthesis gas constituted essentially of carbon monoxide CO and hydrogen H₂ and also carbon dioxide CO₂ and water H₂O is produced. The chemical reaction that takes place can be expressed in the following manner:

CO₂+H₂→CO+H₂O.

This reaction may be carried out at around 800° C. (1100 K) using catalysts, or at around 1200° C. without catalysts. It is pointed out here that all of the gaseous flows remain at temperature in so far as possible. A cooling of the gas at output of the reactor implementing the RWGS reaction according to step c/ may also be envisaged.

According to a subsequent step d/, a cleaning is carried out of the gas produced with separation of the water produced. As indicated in dotted lines in FIGS. 1 and 2, the water produced may potentially be re-injected into the reactor implementing step b/ of high temperature HTE electrolysis.

Finally, according to a step e/, the cleaned CO+H₂ synthesis gas serves as basic reaction intermediate for the production of synthetic products (liquid (FT diesel, “DME”, methanol) or gaseous (SNG) fuels, or synthetic chemicals such as methanol for example). For example, it makes it possible to obtain a liquid fuel by Fisher Tropsch synthesis. As illustrated in dotted lines in FIG. 1, the overhead gas produced may be recycled and injected as input of the oxycombustion according to step a/. In the same way, the water produced during the FT synthesis may be recycled and injected at the input of the HTE electrolysis and the heat released by the synthesis, even at lower temperatures (LT), typically comprised between 200 and 300° C., may serve in the HTE electrolysis according to step b/. Finally, the hydrocarbon chains produced, of average formula —CH₂—, serve as liquid fuel which may be designated usually as a biofuel.

The inventors have performed calculations on the process for the thermochemical conversion of the biomass according to the invention that has been described. More specifically, initial material and energy balance calculations have been performed in order to assess the performances of the process.

An example of balance of species consumed or produced is represented in a synoptic manner in the schematic layout of FIG. 2. It is pointed out here that the values indicated are theoretical values with total reactions.

As a first approximation, the values of the calculation at thermodynamic equilibrium at 1100 K show that with 6 moles of CO₂ (produced from the oxycombustion of one mole of biomass according to step a/), and 12 moles of H₂ (produced from the high temperature electrolysis of 12 moles of H₂O), the RWGS reaction according to step c/ results in 8 moles of H₂ and 4 moles of CO, with a molar ratio H₂/CO=2 necessary for the FT synthesis according to step e/.

Table 1 below summarises the molar balance of species produced in moles per moles of the biomass introduced into an oxycombustion reactor, as well as the pressure and temperature conditions.

TABLE 1
Step by step molar balance.

| | | Oxycombus- | HT | | FT |
|---|---|---|---|---|---|
| | Units | tion | electrolysis | RWGS | synthesis |
| Steps of the | | a/ | b/ | c/ | e/ |
| process | | | | | |
| according | | | | | |
| to the | | | | | |
| invention | | | | | |
| Temperature | K | 1273 | 1100 | 1100 | 500 |
| Pressure | Barg | 1 to 30 | 1 to 30 | 1 to 30 | 20 to 30 |
| | (bar | | | | |
| | gauge) | | | | |
| Biomass | mol | −1.00 | 0.00 | 0.00 | |
| C₆H₈, ₆O_{3.65} | | | | | |
| H₂O | mol | 4.30 | −12.66 | 4.08 | 4.07 |
| O₂ | mol | −6.33 | 6.33 | — | — |
| H₂ | mol | | 12.66 | −12.66 | −8.14 |
| | | | | (input) | |
| | | | | 8.56 | |
| | | | | (output) | |
| CO | mol | | | 4.07 | −4.07 |
| CO₂ | mol | 6.00 | | −6.00 | |
| CH₂ - | mol | | | | 0.82 |
| overhead | | | | | |
| gas | | | | | |
| CH₂ - fuel | mol | — | | | 3.25 |

It is pointed out that the calculations presented in the above table were performed with a biomass flow rate at input of 10 t/h and that the composition at the output of the reactor implementing the RWGS reaction according to step c/ is calculated at thermodynamic equilibrium.

It is also pointed out that, by hypothesis, 80% conversion efficiency of the CO into liquid fuel has been considered.

In this configuration and for an input flow rate of 10 t/h of biomass, the powers exchanged are those indicated in table 2 below. They are noted negatively when they are released (exothermic) and positively when they are consumed (endothermic).

TABLE 2
Powers produced and consumed at each step.

| | | Oxycombus- | HT | RWGS | FT |
|---|---|---|---|---|---|
| | | tion | electrolysis | reaction | synthesis |
| Steps | Units | a/ | b/ | c/ | e/ |
| Exo- | | a/ | | | e/ |
| thermic | | | | | |
| steps | | | | | |
| Power | MW | −43.02 | | | |
| Electricity | | −17.02 | | | |
| produced | | | | | |
| Residual | | −25.81 | b/ | c/ | −13.40 |
| heat | | | | | |
| Endo- | | | b/ | c/ | |
| thermic | | | | | |
| steps | | | | | |
| Power | Mw | | 81.63 | 2.73 | |
| Enthalpy | Kwh/Nm³ | | 2.32 | | |
| reaction | of H₂ | | | | |
| Enthalpy | | | 1.68 | | |
| heat | | | | | |
| Electricity | MW | | 47.29 | | |
| require- | | | | | |
| ment | | | | | |
| Heat | | | 34.34 | 2.73 | |
| require- | | | | | |
| ment | | | | | |

It is pointed out there that as regards heat, there is vaporisation and latent heat up to 800° C.

It is also pointed out that it is considered that the electricity produced by the cogeneration reactor according to step a/ may be recovered with an efficiency of 40%, given the temperatures attained.

Finally, the enthalpy of reaction of the FT synthesis exothermic reaction equal to −0.165 MJ/mol has been considered.

From table 2, it may be deduced that:
the electrical requirement (47 MW) is greater than that which may be produced (17 MW). It is thus necessary to import electricity from an external source to implement the process of conversion according to the invention;
the heat demand and production balance out. The temperature levels can enable the transfer of heat from the hot exothermic areas to the cold endothermic areas.

Finally, table 3 below summaries the efficiencies of the process according to the invention.

It is pointed out that, in this table, the mass efficiency is defined as the ratio between the mass flow rate of fuel produced and the mass flow rate of biomass at input of the process.

Similarly, the energy efficiency is defined as the ratio between the energy content of the product obtained at output of the process and the energy introduced into the process (energy contained in the biomass+injected electrical energy).

TABLE 3
Summary table of the efficiencies of the process of the invention.

| | Units | Values |
|---|---|---|
| Biomass flow rate | kg/h | 10000 |
| Flow rate of CH₂ fuel | | 4101 |
| produced | | |
| Mass efficiency (liquid CH₂ | % | 33 |
| uniquely) | | |
| Mass efficiency (liquid CH₂ | % | 41 |
| and overhead gas) | | |
| LCV(*) products at input | MW | 50.00 |
| Electricity | | 30.09 |
| Heat | | −2.15 |
| LCV(*) products at output CH₂ | MW | 45.57 |
| (with overhead gas) | | |
| Energy efficiency | % | 57 |
| Primary energy efficiency | | 34 |
| Biomass consumption | J/J produced | 1.10 |
| Electrical consumption | | 0.66 |

(*)LCV: Lower Calorific Value

It is pointed out here that the unit J/J produced designates the energy ratio in joule/joule between the energy injected into the process (in the form of biomass or electricity) and the energy of the product obtained. Thus, the table shows that for 1 joule of biofuel manufactured by means of the process according to the invention, it is necessary to inject the equivalent of 1.1 joules of biomass and 0.66 joules of electricity.

It is also pointed out that in this balance electricity needs to be input from the exterior, losses are not considered and that the heat at relatively low temperature generated by the FT synthesis serves in the production of steam for the HTE electrolysis according to step b/.

Table 4 below summarises in a comparative manner the efficiencies of the process according to the invention and those of a reference process given in the publication [2]. This reference process is designated by the number [14] of table 1 in this publication and in English as follows: “Torrefied Wood—Autothermal—HT heat exchanger—H2 (electricity)—with tail gas recycle”. This process is thus a sequencing of elementary processes as follows:

Torrefaction-gasification in an autothermic reactor (energy supplied by the partial combustion of the biomass with air enriched with O₂)—Exchange of heat at high temperature-production of H₂— recycling of the overhead gas.

TABLE 4
Comparison of the efficiencies of the process
of the invention and the reference process.

| | | | Reference process |
|---|---|---|---|
| | | Process according | [14] according to |
| | Units | to the invention | publication [2] |
| Mass efficiency | % | 41 | 50 |
| Energy efficiency | | 57 | 51 |
| Primary energy | | 34 | 25 |
| efficiency | | | |
| Biomass | J/J produced | 1.10 | 0.85 |
| consumption | | | |
| Electrical | | 0.66 | 0.98 |
| consumption | | | |
| Natural gas | | 0 | 0.13 |
| consumption | | | |

From this table 4, it may be deduced that the performances of the conversion process according to the invention are better than those of the reference process in terms of energy efficiencies and energy requirements external to the process, particularly in electricity.

This may be attributed in particular to the fact that the overall electrical requirement is lower than an allothermic process, and there is no energy lost in the step of preparation of the feedstock, on account of the elimination of the step of torrefaction and grinding of the biomass.

As a general rule, the process according to the invention can make it possible to attain better performances than those of production processes known as BtL (Biomass to Liquid) which are the present reference: see publication [2].

To attain even higher performances, it is possible to improve the material yield by recovering the same number of carbons as in the reference process of [2], in other words 5.3 instead of 4.07 in the process of the invention. To do so, the inventors think that there is reason to shift the equilibrium of the RWGS reaction according to step c/. In this case, the inventors think that it is necessary either to make an addition of H₂ in excess at the inlet of the reactor implementing the RWGS reaction or to carry out an internal recycling of gas with separation between carbon monoxide CO and hydrogen H₂. It is possible to better assess these improvements by calculation, for example from the ProsimPlus® software developed by the firm Prosim.

Table 5 below indicates the values obtained with an equilibrium of the RWGS reaction shifted so as to obtain a number of recoverable carbons equal to 5.3.

TABLE 5
Summary table of the efficiencies of the process
improved by shifting the equilibrium.

| | Units | Value |
|---|---|---|
| Biomass flow rate | kg/h | 10000 |
| Flow rate of CH₂ fuel | | 5338 |
| produced | | |
| Mass efficiency (liquid CH₂, | % | 53.4 |
| and overhead gas) | | |
| LCV(*) products at input | MW | 50.00 |
| Electricity | | 32.48 |
| Heat | | −3.61 |
| LCV(*) products at output | | 59.31 |
| CH₂ (with overhead gas) | | |
| Energy efficiency | % | 72 |
| Primary energy efficiency | | 40 |
| Biomass consumption | J/J produced | 0.84 |
| Electrical consumption | | 0.55 |

(*)LCV: Lower Calorific Value

These calculations corroborate the hypothesis of the inventors, since the performances of the process at shifted RWGS reaction equilibrium are higher than those of the process indicated in the preceding table 3.

It goes without saying that it may be considered that the values indicated above are greater than the real values that can be hoped for due to the fact that they are derived from calculation. This being the case, they can be compared to the reference values given in the publication [2] already mentioned in the preamble which are also derived from calculation. A material yield is attained here comparable to that of the reference process of the publication [2], a comparable consumption of biomass and a much higher energy efficiency (72% compared to 51%), as well as a lower external addition of electricity (0.55 J/J compared to 0.85 J/J).

### REFERENCES CITED

[1]: Technique de l'Ingénieur Manuel G2051 “Traitements thermiques des déchets>>, paragraphe 3 <<Procédé d'oxycombustion××, Gérard Antonini;

[2]: “Technical and economical evaluation of enhanced biomass to liquid fuel processes”, Jean-Marie Seiler, Carole Hohwiller, Juliette Imbach, Jean-Francois Luciani, Energy, 35, 3587-3592, (2010).

1. Process for the thermochemical conversion of a carbon-based feedstock to synthesis gas containing predominantly hydrogen (H₂) and carbon monoxide (CO), comprising the following steps:
(a) oxycombustion of the carbon-based feedstock to create a cogeneration of electricity and of heat;
(b) high-temperature electrolysis (HTE) of water using at least the heat produced according to step (a);
(c) reverse water gas shift (RWGS) reaction starting from the carbon dioxide (CO₂) produced according to step (a) and the hydrogen (H₂) produced according to step (b).

2. Process for the thermochemical conversion of a carbon-based feedstock to synthesis gas according to claim 1, wherein the high-temperature electrolysis (HTE) of water of step (b) is also carried out using the electricity produced according to step (a).

3. Process for the thermochemical conversion of a carbon-based feedstock to synthesis gas according to claim 1, wherein all the oxygen produced by the electrolysis (HTE) according to step (b) is used as oxidising agent of the oxycombustion step (a).

4. Process for the thermochemical conversion of a carbon-based feedstock to synthesis gas according to claim 1, wherein only part of the oxygen produced by the electrolysis (HTE) according to step (b) is used as oxidising agent of the oxycombustion step (a), the other part being recovered.

5. Process for the thermochemical conversion of a carbon-based feedstock to synthesis gas according to claim 1, wherein the water (H₂O) produced by the RWGS reaction according to step (c) recycled and injected as input product of the HTE electrolysis according to step (b).

6. Process for the thermochemical conversion of a carbon-based feedstock to synthesis gas according to claim 1, further comprising a step (d) of cleaning of the gas obtained according to step (c) so as to extract hydrogen (H₂) and carbon monoxide (CO).

7. Process for the thermochemical conversion of a carbon-based feedstock to synthesis gas according to claim 6, wherein the carbon dioxide (CO₂) cleaned according to step (d) is injected as input product for the RGWS reaction according to step (c).

8. Process for the thermochemical conversion of a carbon-based feedstock to synthesis gas according to claim 6, wherein the water (H₂O) derived from the cleaning of the gas according to step (d) is recycled and injected as input product of the HTE electrolysis according to step (b).

9. Process for the thermochemical conversion of a carbon-based feedstock to synthesis gas according to claim 6, wherein the carbon monoxide (CO) and the hydrogen (H₂) derived from the cleaning according to step (d) are injected as input products of a step (e) according to which a Fischer Tropsch (FT) synthesis is carried out to obtain a liquid fuel.

10. Process for the thermochemical conversion of a carbon-based feedstock to synthesis gas according to claim 9, the water (H₂O) derived from the Fischer Tropsch FT synthesis according to step (e) is recycled and injected as input product of the HTE electrolysis according to step (b).

11. Process for the thermochemical conversion of a carbon-based feedstock to synthesis gas according to claim 9, wherein the overhead gas of the FT synthesis according to step (e) is injected as input product of the oxycombustion according to step (a).

12. Process for the thermochemical conversion of a carbon-based feedstock to synthesis gas according to claim 9, wherein the heat generated by the FT synthesis according to step (e) serves in the production of steam at input of the HTE electrolysis according to step (b).

13. Process for the thermochemical conversion of a carbon-based feedstock to synthesis gas according to claim 1, wherein the carbon-based feedstock is biomass.

14. Process for the thermochemical conversion of a carbon-based feedstock to synthesis gas according to claim 13, wherein the biomass moisture level is less than 50%.
